(19) United States
(12) Patent Application Publication
(10) Pub. No.: US 2008/0162728 A1
(43) Pub. Date: Jul. 3, 2008

(54) SYNCHRONIZATION PROTOCOL FOR LOOSELY COUPLED DEVICES

(75) Inventors: Rafik Robeal, Redmond, WA (US); Sudarshan A. Chitre, Redmond, WA (US); Steven M. Lasker, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/619,262

(22) Filed: Jan. 3, 2007

(51) Int. Cl. G06F 15/16

(52) U.S. Cl. 709/248

(57) ABSTRACT

A transport agnostic synchronization protocol is provided for use in the context of loosely coupled clients. The synchronization protocol enables a stateless server freeing the server from maintaining synchronization state of ever scaling clients. A discoverability service is provided for clients to learn about different synchronization services for groups of data that the server provides such that the clients can choose or subscribe to synchronization groups of interest, and the protocol initializes the client with any schema of any data structures to which it subscribed that are unknown. Further, the protocol enables an extensible synchronization anchor model that carries an anchor type between client and server without requiring assumptions about client data structures allowing a wide spectrum of anchor data types and functionality.

### TECHNICAL FIELD

The subject disclosure relates to a synchronization protocol for synchronizing data among clients and server data stores where the clients may come out of contact with the servers for indefinite periods, e.g., for offline applications.

### BACKGROUND

To synchronize data of a data store from a server to several clients, and vice versa, a synchronization protocol must be set in place to handle the synchronization and replication that must take place among the various devices. Assurance of proper synchronization and replication becomes complex, however, when the clients are allowed to come in and out of contact with the server.

To date, a small number of client-server synchronization and replication protocols have been implemented for relational database engines and clients wishing to synchronize to data in the relational database, e.g., structured query language (SQL) Merge and Transactional replication is based on one such protocol. However, these client-server synchronization and replication protocols suffer from a number of drawbacks due to inflexibility.

For instance, common characteristics shared for existing synchronization/replication protocols for these relational database engines include: (1) they implement a complex object model, (2) they are tightly coupled and (3) scalability is limited. For instance, these protocols introduce new complex data structures making the implementation of the protocol a complex undertaking, making the problems difficult to understand by the client/application developer audience. With respect to tight coupling, existing protocols assume a tight coupling between the server and client, which is not suitable for loosely coupled internet clients or service oriented architecture (SOA) models within enterprises. These protocols also have limited scalability because the traditional tightly coupled protocol often puts requirements on the server to keep metadata about all its clients, and the overhead of managing this metadata reduces the server scalability.

Thus, what is desired is a synchronization protocol that addresses each of the above-identified problems in the state of the art of synchronization and replication of data between a server and loosely coupled clients. More particularly, a familiar object model is desired that presents a simple synchronization protocol for application developers by implementing concepts and data types with which developers are already familiar. In addition, a synchronization protocol is desired for loosely coupled devices and a highly scalable server is desired whose performance does not degrade due to the high costs of maintaining client state.

Accordingly, in consideration of the lack of sophistication of the current state of the art of synchronization of data between a server and loosely coupled clients, it would be desirable to provide an improved synchronization protocol and corresponding methods. These and other deficiencies in the state of the art of synchronization in the context of loosely coupled devices will become apparent upon description of the various exemplary non-limiting embodiments of the invention set forth in more detail below.

### SUMMARY

The present invention provides a transport agnostic synchronization protocol and corresponding methods for use in the context of loosely coupled clients. The synchronization protocol enables a stateless server freeing the server from maintaining synchronization state of its clients and enabling scalability to many clients. A discoverability service is provided for clients to learn about different synchronization services for groups of data that the server provides such that the clients can choose or subscribe to synchronization groups of interest, and the protocol initializes the client with any schema of any data structures to which it subscribed that are unknown. Further, the protocol enables an extensible synchronization anchor model that carries an anchor type between client and server without requiring assumptions about client data structures allowing a wide spectrum of anchor data types and functionality.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The synchronization protocol of the present invention is further described with reference to the accompanying drawings in which:

FIG. 1 is a block diagram of an exemplary non-limiting architecture for synchronizing with offline applications in accordance with the protocol of the invention;

FIG. 2 is a flow diagram illustrating an exemplary, non-limiting implementation of the protocol of the invention for synchronizing sync groups in accordance with the invention;

FIG. 3 is a flow diagram illustrating an exemplary, non-limiting implementation of the protocol of the invention for discovering sync groups from the server and corresponding schema;

FIG. 4 is a block diagram illustrating exemplary aspects of an extensible synchronization anchor model of the invention;

FIGS. 5A and 5B illustrate an exemplary non-limiting Data Set implementation for the passing of data structures back and forth between client and server without a priori knowledge of client or server side storage structures.

FIG. 6 illustrates the scalability of the synchronization of the invention to many clients, for example, as part of a hub and spoke synchronization model.

FIG. 7 is a flow diagram implementing an exemplary non-limiting process for synchronization from the perspective of a server of the invention;

FIG. 8 is a block diagram representing an exemplary non-limiting networked environment in which the present invention may be implemented; and

FIG. 9 is a block diagram representing an exemplary non-limiting computing system or operating environment in which the present invention may be implemented.

### DETAILED DESCRIPTION

### Overview

As discussed in the background, existing synchronization protocols implement an overly complex object model, are too tightly coupled to be useful for offline applications and their scalability is limited due to server overhead. Accordingly, in consideration of these deficiencies in the state of the art, the present invention provides an improved synchronization protocol and corresponding methods for use in the context of loosely coupled clients.

The invention provides a synchronization protocol that uses concepts and data types with which developers are familiar. The synchronization protocol of the invention is also a transport agnostic protocol that enables a stateless server, i.e., the server is freed from the requirements of maintaining synchronization state of its clients. As a result of freeing the server from such management responsibilities, the invention is highly scalable to a large number of clients since the protocol does not require the server to keep the state of its clients. Thus, synchronization state metadata for clients is maintained on the clients in accordance with the invention.

In addition, the synchronization protocol of the invention provides a discoverability service so that clients can learn about different synchronization services for groups of data that the server provides such that the clients can choose or subscribe to synchronization groups of interest.

### Synchronization Protocol for Offline Applications

As mentioned, the synchronization protocol of the invention provides a variety of advantages over the state of the art. For instance, the synchronization protocol of the invention enables a stateless server model where the protocol does not assume the server has a prior knowledge of the client, enabling server implementations that are scalable to a large number of clients.

In various non-limiting embodiments, the synchronization protocol of the invention enables a discovery and initialization model so that when a client encounters a server, the client can discover sync groups exposed from the server. Once a client subscribes to one or more sync groups exposed from the server, if the client does not already have the appropriate schema for tables in the sync groups, the protocol initializes the client with any schema the client uses that are not already accessible from the client.

In other exemplary, non-limiting embodiments of the synchronization protocol of the invention, an extensible synchronization anchor model is provided where the protocol carries an anchor type between a client and server, but does not assume any particular structure on the client—thus allowing a wide spectrum of anchor data types with varying level of features to be utilized. In addition, this allows developers to build synchronization applications against an existing server without having to change the anchor format on the server, further minimizing server impact.

In still further non-limiting embodiments of the synchronization protocol of the invention, a metadata storage model is provided whereby the client stores the sync metadata, freeing the server from maintaining any synchronization metadata about the client.

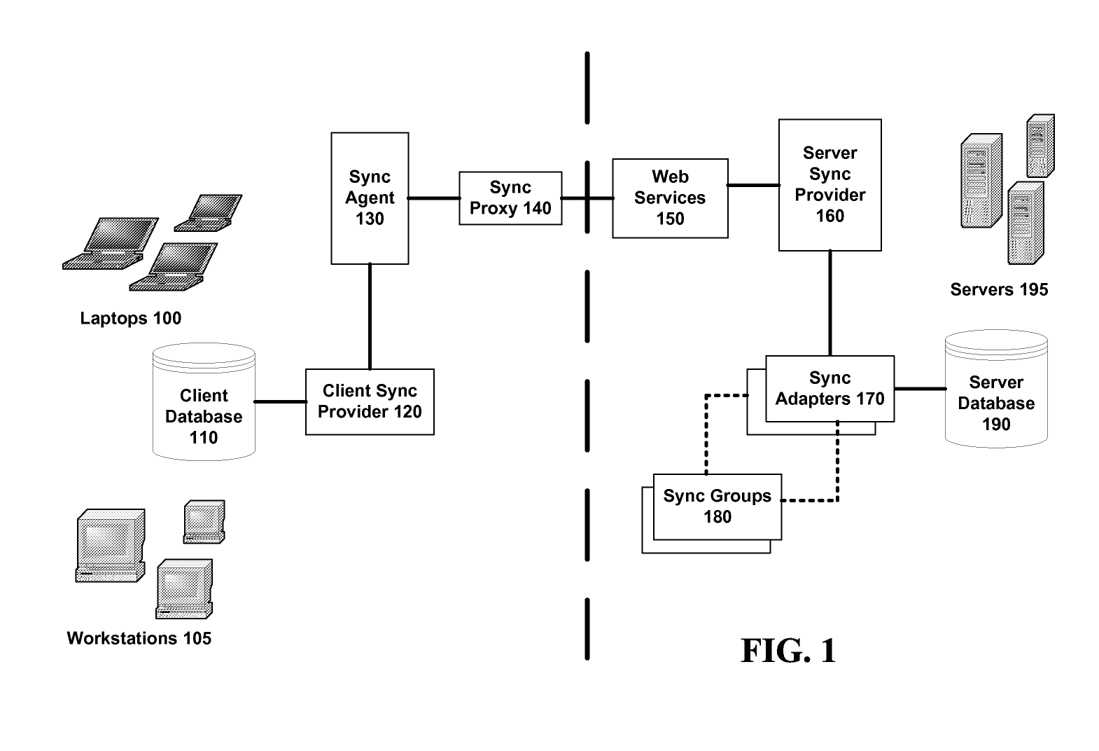

As mentioned, the synchronization protocol of the invention can be used to support offline applications. An overview of the application framework including offline applications is shown in the exemplary non-limiting block diagram of FIG. 1.

FIG. 1 depicts the architecture of an N-Tier scenario. On the client side, the synchronization protocol is orchestrated by sync agent components 130. It is noted, however, that the synchronization protocol of the invention is transport agnostic. Thus, FIG. 1 depicts but one possible transport implementation using web services 150. The sync agents 130, located on the client side, are the core sync engine and implement the logic used to: (A) collect metadata from the client and server databases, (B) upload and download changes to and from the server database to the client provider or (C) propagate error, progress and conflict events to the client application.

The sync agent(s) 130 use sync adapters 170 to interact with the server database 190 through server sync provider interface(s). In addition, each sync adapter 170 defines the table and column mapping for each table being synchronized between client and server along with logical grouping of two or more tables.

The sync agent 130 accepts a client sync provider 120 and server sync provider 160, which hide the client database 110 and server database 120 specifics, respectively, from the agent 130.

The sync agent 130 accepts a collection of sync groups 180 and runs the protocol provided by the invention in order to bring these groups 180 in sync. Sync adapter 170 instructs the sync agent 130 how to interact with the server database 190. In this regard, sync agent 130 does not interact directly with sync adapters 170, but rather sync agent 130 interacts with the server provider 160 which in turn uses the sync adapters 170 to connect to the database 190. This interaction is defined through one or more of the following database command objects in accordance with non-limiting embodiments of the invention: Insert, Update, Delete, Select Incremental Inserts, Select Incremental Updates, Select Incremental Deletes, Select Update Conflict and/or Select Delete Conflict commands.

The insert command in accordance with the invention is used by the server sync provider to propagate inserts on the client database to the server database.

The update command in accordance with the invention is used by the server sync provider to propagate updates on the client to the server database

The delete command in accordance with the invention is used by the server sync provider to propagate deletes on the client to the server database.

The select incremental inserts command in accordance with the invention is used by the server sync provider to enumerate inserts that took place on the server since the last time the client synced.

The select incremental updates command in accordance with the invention is used by the server sync provider to enumerate updates that took place on the server since the last time the client synced.

The select incremental deletes command in accordance with the invention is used by the server sync provider to enumerate deletes that took place on the server since the last time the client synced.

The select update conflict command in accordance with the invention is used by the server sync provider to obtain the existing row that led to the failure of insert, update or delete commands. This command performs a lookup of the conflicting row in the data table.

The select delete conflict command in accordance with the invention is used by the server sync provider to get hold of the existing row that led to the failure of insert, update or delete commands. In one embodiment, this command performs a lookup of the conflicting row in the tombstone table to find the row in the tombstone table that leads to the failure of the update command, but is not used when insert or delete commands fail.

In one non-limiting embodiment, the sync adapter 170 of the invention is implemented similar to Data Adapter in ActiveX Data Object (ADO.NET) by using or extending Data Adapter constructs, though for the avoidance of doubt, the invention is not limited to implementations similar to Data Adapter.

With respect to server sync providers 160 in accordance with the invention, in one non-limiting embodiment, both default and custom providers 160 are enabled. Default providers 160 are provided to address common application scenarios (e.g., thin client scenario, rich client scenario, SQL mobile, SQL express, etc.). Application developers and third parties may also implement custom providers 160 for less common scenarios (e.g., Access, FoxPro) via a simple framework and helper classes for such custom providers 160. Some of the embodiments and examples used herein pertain to database storage of data, though for the avoidance of doubt, the client or server data store can be any data store.

In various non-limiting embodiments of the invention, functionality of sync provider 160 includes, but is not limited to: the ability to store sync information for groups 180, the ability to enumerate incremental changes that took place on the database since the last sync, the ability to apply incremental changes to the database, the ability to detect conflicting updates and optionally resolve them programmatically or interactively and the ability to fire progress and data change events.

With respect to sync proxy 140, solutions that require direct connection to the server database 190 are rarely seen these days as SOA based solutions are growing in popularity. With a SOA model, the server 195 exposes its functionality as a web service 150 that connects to the server 195 on demand. The client interacts with the web service 150 through the internet or through a local intranet in an enterprise. The sync proxy component 140 is thus a simple interface that enables building of disconnected SOA solutions, though as emphasized earlier, any transport mechanism for the synchronization protocol may be used in accordance with the invention.

Thus, FIG. 1 describes an exemplary non-limiting synchronization environment for applications running on laptops 100 and workstations 105 to each synchronize with one or more sync groups 180 defined for data in server database 190 as maintained by servers 195.

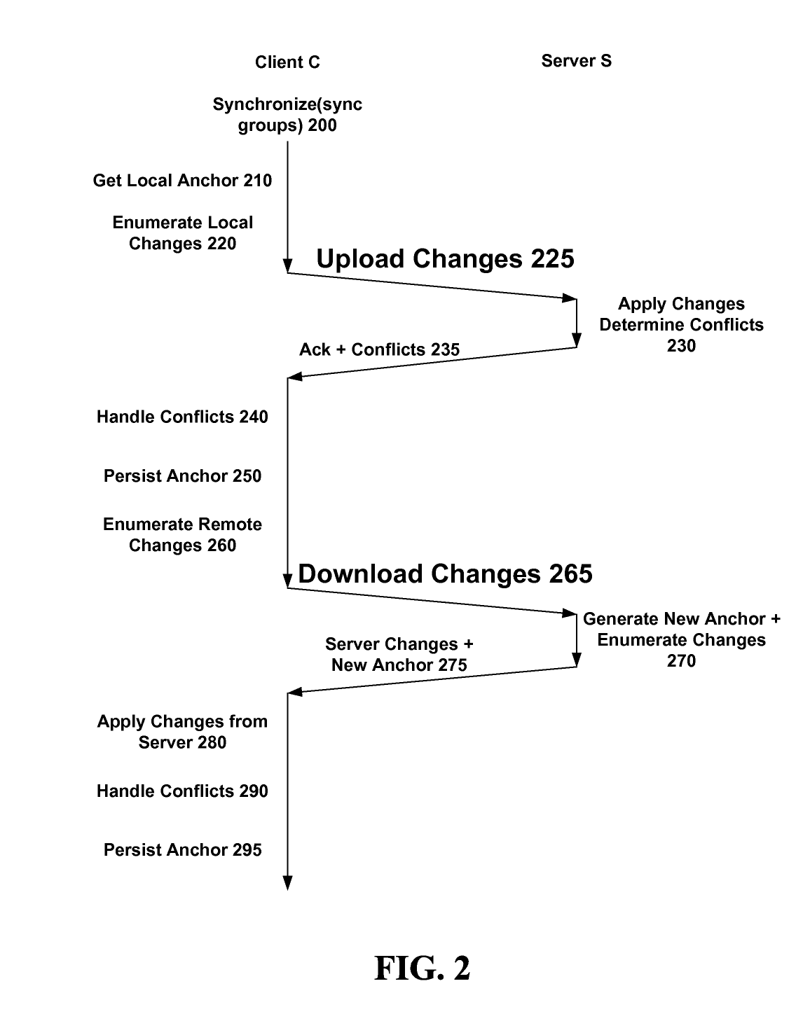

An exemplary, non-limiting implementation of the synchronization protocol in accordance with the invention is illustrated in the flow diagram of FIG. 2 representing various client processing steps initiated by a client C (shown on the left side) to synchronize with a server S according to various server processing steps (shown on the right side) according to the synchronization protocol.

As shown in the exemplary, non-limiting flow diagram of FIG. 2, in response to a call to a “Synchronize( )” command by a client C to a server S made at 200, the client-side sync agent collects metadata information for desired sync groups as passed to the Synchronize( ) call, i.e., retrieves a local synchronization anchor at 210.

A sync anchor is information, such as a string, representing a synchronization event as a position in synchronization time. For instance, multiple sync anchors can be defined such as Last and Next, describing the last event when the database was synchronized, and the current sync event, respectively, from the sending device's point of view. The receiving device then stores each Next sync anchor at some point for use in connection with a future synchronization. A comparison of Last and Next sync anchors enables a determination of what sync groups should be updated.

It should also be noted that, at anytime, or as part of the initial Synchronize( ) call, if the sync agent detects a new sync group is available from server S, a schema initialization part of the synchronization protocol of the invention is begun (not shown in FIG. 2) in order to understand the rules for representing data structures of the new sync group.

For each sync group included in the Synchronize( ) call, at 220, the sync agent requests changes from the client sync provider into a data set object and uploads the group changes to the server at 225.

At 230, the server sync provider applies the changes received to each table in the group (e.g., inserts in same table order in the group, deletes in reverse order).

At 235, the server sync provider collects conflicts encountered when applying the changes at 230 and generates an acknowledge that the changes were applied, and returns them back to the client for post processing.

At 240, the sync agent receives the acknowledge (ACK) from applying the changes at the server at 230 and performs any conflict resolution or error reporting based on any sync and conflict policies defined for the client.

At 250, the sync agent stores, or persists, the local anchor at the local database for a next upload phase, wherein the client collects the next set of metadata information for desired sync groups for comparison to the persisted local anchor.

From the client perspective, the download phase 265 starts at 260 by making a call to the server to enumerate changes for the same sync group and blocks until the call returns.

At 270, the server sync provider obtains a new anchor for the sync group(s) and then enumerates all changes for each table in the group(s) and, in an exemplary, non-limiting embodiment, packages the changes in one or more dataset objects. In one embodiment, one dataset is returned per request that includes data for all the tables in the sync group. The changes are then sent from the server to the client at 275.

At 280, the client sync agent receives the changes and the new anchor from the server, parses the changes and applies each row.

At 290, the sync agent in turn handles any conflicts encountered when applying the rows based on an applied or default conflict policy.

At 295, the sync agent then stores the received anchor from the server in the local database before concluding the synchronization session.

The above-described synchronization protocol provides benefits that are suited for offline applications that are not in constant contact with a server, but wish to sync to the server. For instance, the protocol enables a stateless server model in that the protocol does not assume the server has a prior knowledge of the sync state of the client, which enables a scalable server implementation because client metadata does not build up on the server. In this regard, the protocol enables a client metadata storage model where the client stores the sync metadata, freeing the server from the overhead of storage, maintenance and other processing of client sync metadata, especially as client devices syncing via the protocol proliferate.

As mentioned, the protocol of the invention also includes a discovery and initialization model for discovering schema for any desired sync groups for which the client does not already have the applicable schema. The protocol enables clients to discover the sync groups exposed from a certain server. The protocol also initializes the client with the schema(s) of the tables to which the client subscribed for synchronization purposes if the schemas do not already exist on the client.

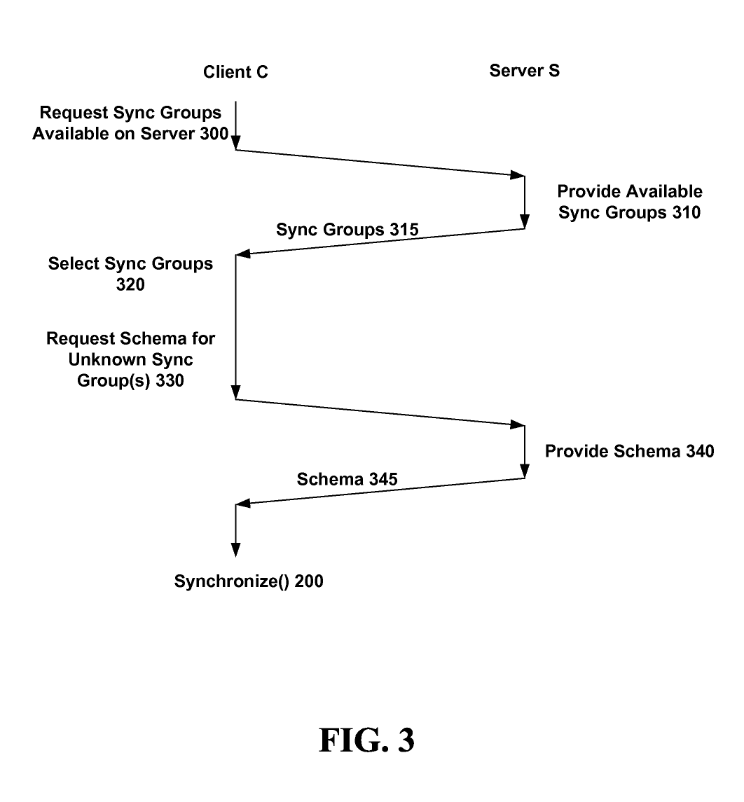

FIG. 3 illustrates an exemplary, non-limiting implementation of discovery and initialization processes enabled by the protocol of the present invention. At 300, a client C requests sync groups available on server S. Based on client C and the request for sync groups, server S determines what sync groups are available to which client C has permission to sync, for example, but not limited basing the determination on subscription rights, security level, and the like pertaining to the client request. The available sync groups for client synchronization are sent to the client C at 315. A client C may select a subset of those available sync groups at 320, either explicitly or implicitly, however the client C may not possess or otherwise have access to the schema pertaining to all of the selected sync groups. Thus, client C then requests schema for any unknown sync group(s) at 330, e.g., by identifying the sync group(s) for which the client C does not have the schema. Server S receives the request at 340 and retrieves or provides schema for any sync group(s) to which the server S has access to client C at 345. Then, client C is ready to synchronize according to step 200 of FIG. 2.

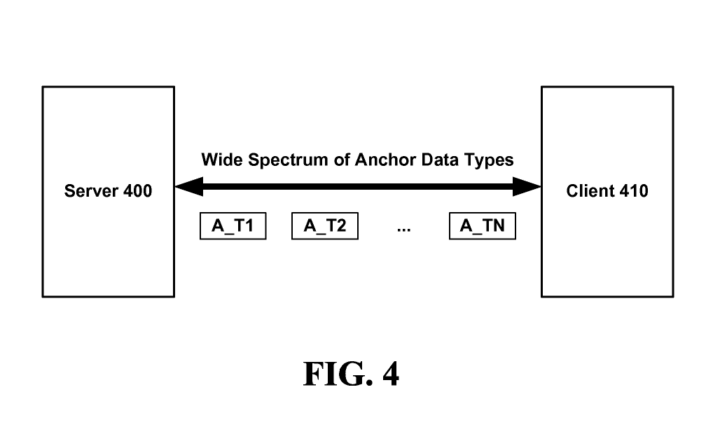

In further non-limiting embodiments, the invention enables an extensible sync anchor model by providing a protocol that carries an anchor type between client and server, but does not assume any pre-defined structure on the client and thus flexibly allows a wide spectrum of anchor data types with varying level of features. FIG. 4 illustrates that a variety of anchor types A_T1, A_T2, . . . , A_TN can be passed back and forth between a server 400 and a client 410 in accordance with the protocol of the invention. In addition, the structure of the anchor is defined by the server and advantageously, the client does not need to understand the format in order to sync with the server.

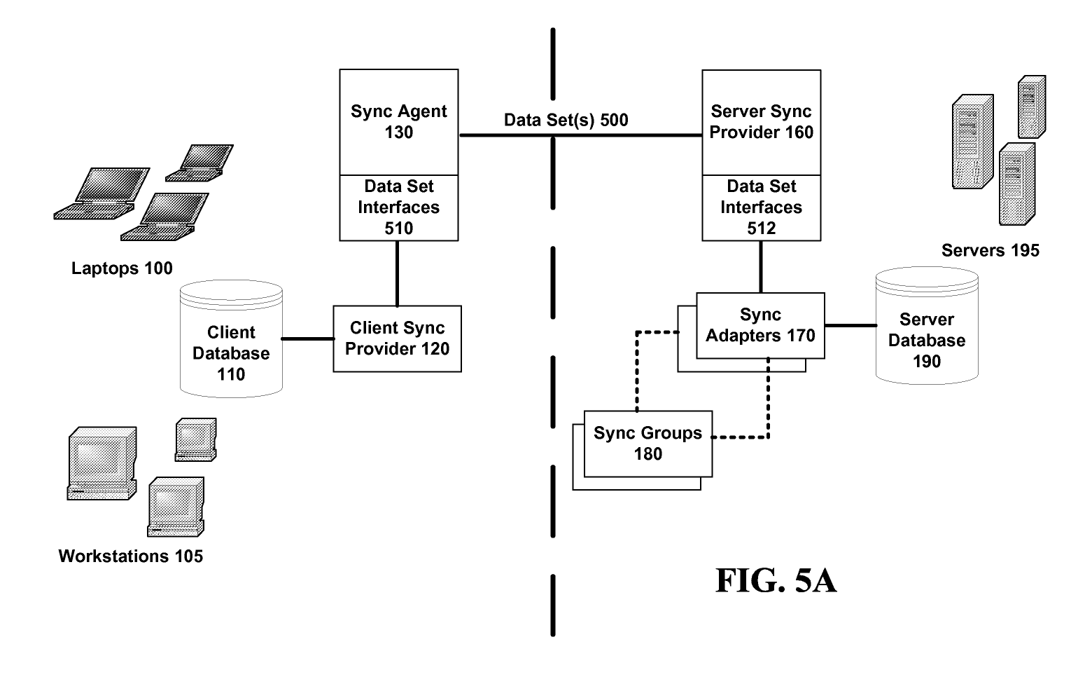

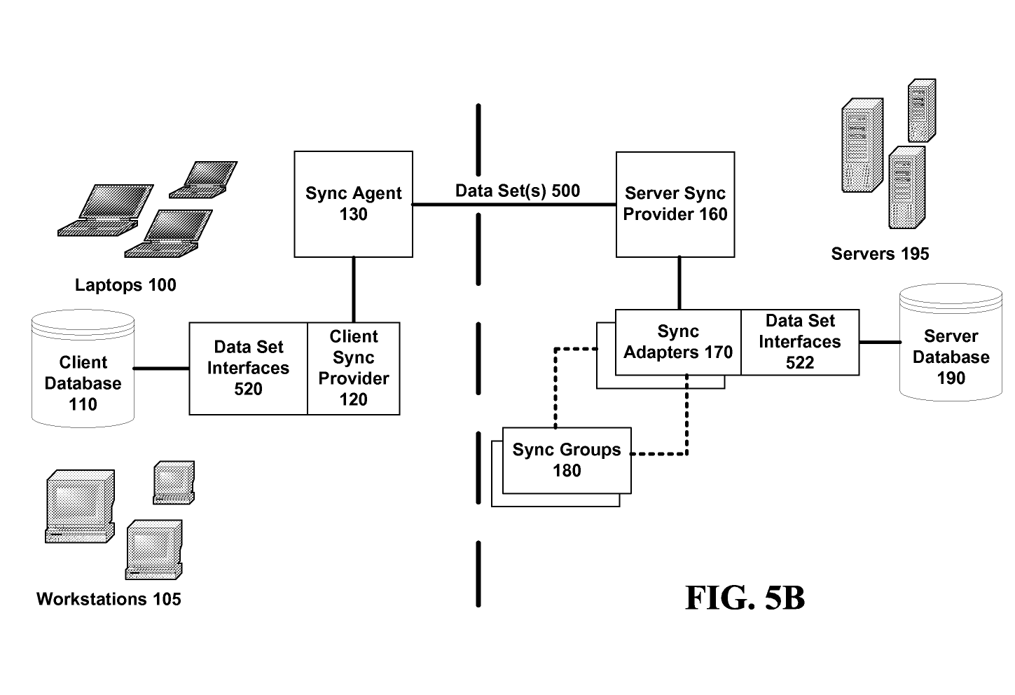

FIG. 5A illustrates an exemplary embodiment of the invention where Data Set data structures 500 (i.e., ADO.NET V2 DataSet objects) are passed between a client side sync agent 130 and a server side sync provider 160. Data Set interfaces 510 are provided on the client side to translate to and from Data Set data structures 500 and Data Set interfaces 512 are provided on the server side to translate to and from Data Set data structures 500. Alternatively, as shown in FIG. 5B, Data Set Interfaces 520 and 522 on the client side and server side, respectively, can be utilized to translate to and from Data Set data structures in connection with client database 110 and server database 190, respectively. For the avoidance of doubt, the foregoing Data Set implementations are non-limiting and thus, other data structures may be utilized to represent synchronization data to and from clients and servers in accordance with the invention, along with the appropriate interfaces. Whatever implementation selected, the protocol of the invention is thus able to operate in a transport independent manner without needing to know the exact format of data storage for either the client or server sides.

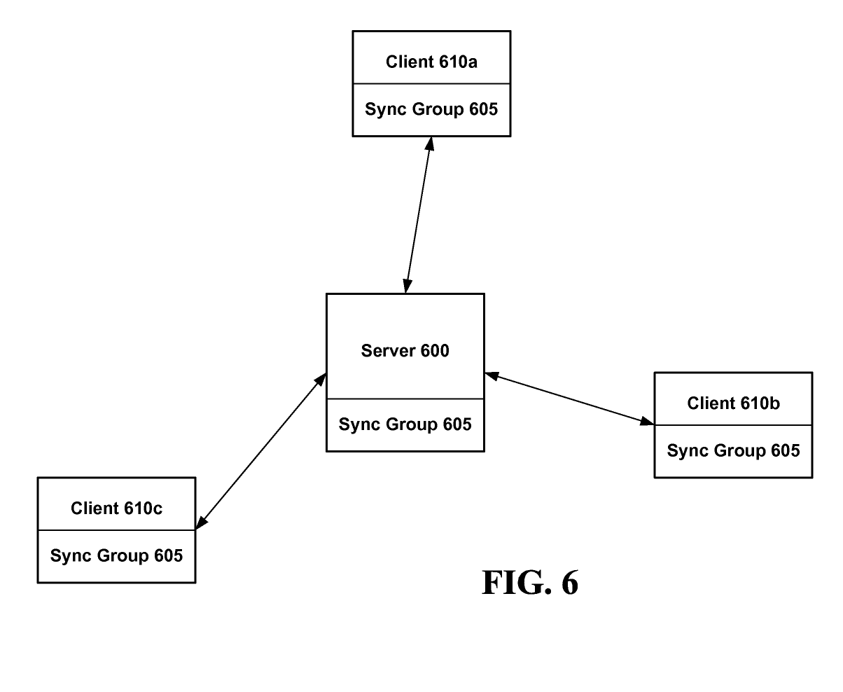

Advantageously, since client metadata is stored on a client, as shown in FIG. 6, the synchronization protocol of the invention can be used to synchronize data according to a hub and spoke model where clients 610a, 610b, 610c, etc. can come into contact with a server 600 and each synchronize with the data of sync group 605. Based on temporal properties, such as timestamps, of the data being synchronized and according to conflict resolution policy, a consistent set of data of sync group 605 can be maintained at server 600 and at clients 610a, 610b, 610c whenever the clients come into contact with the server.

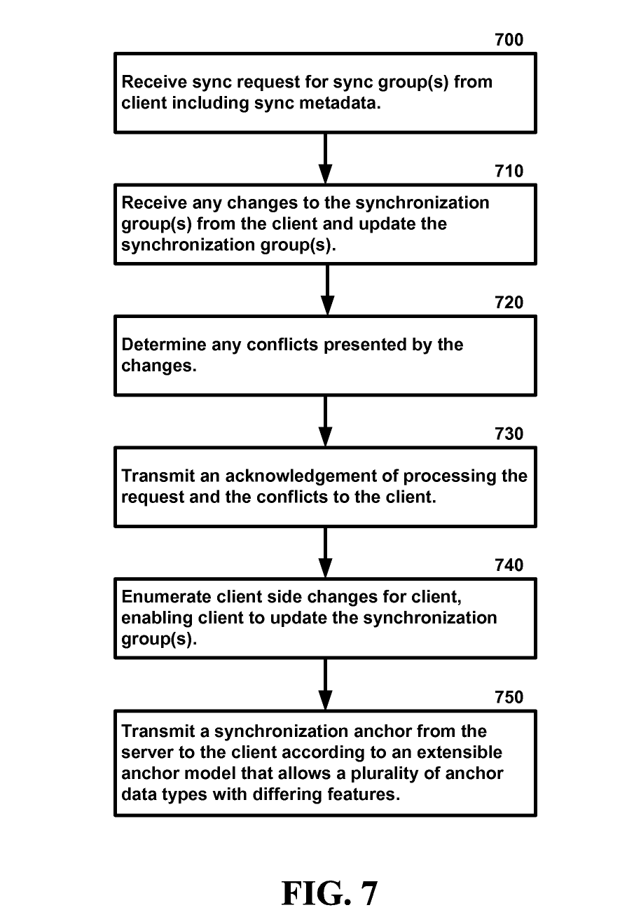

FIG. 7 is a flow diagram implementing an exemplary non-limiting process for synchronization from the perspective of a server of the invention. At 700, a sync request is received for sync group(s) from a client including sync metadata. At 710, any changes to the synchronization groups(s) are received from the client and the synchronization group(s) are updated. At 720, any conflicts presented by the changes are determined. At 730, an acknowledgement of processing the request and the conflicts are sent to the client. At 740, client side changes are enumerated for the client, enabling the client to update the synchronization group(s). At 750, a synchronization anchor from the server is transmitted to the client according to an extensible anchor model that allows a plurality of anchor data types with differing features.

### Exemplary Networked and Distributed Environments

One of ordinary skill in the art can appreciate that the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with the synchronization protocol of the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the synchronization protocol of the invention.

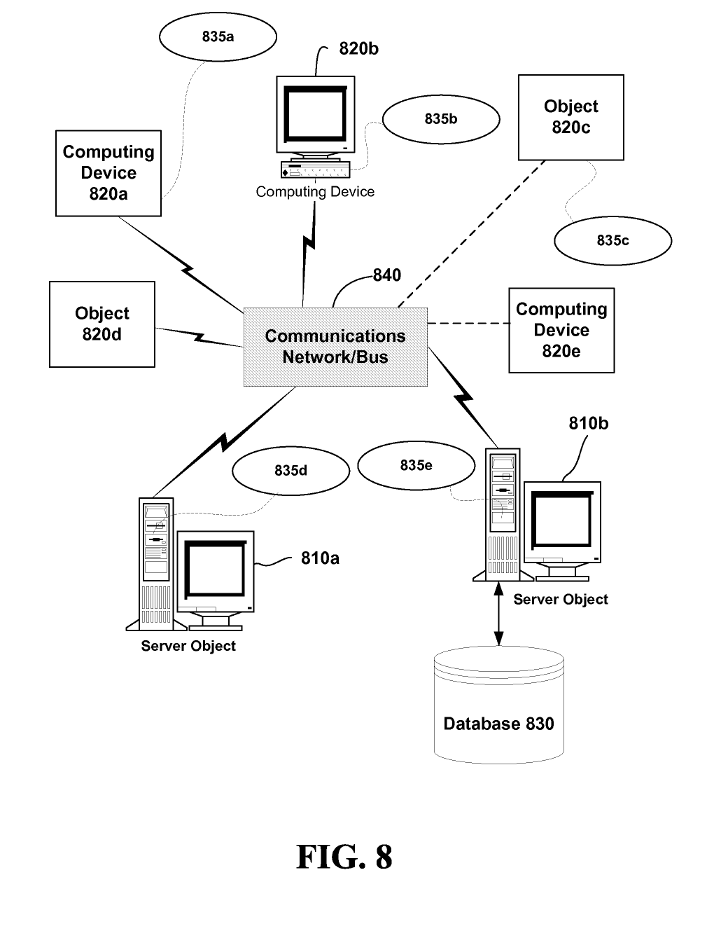

FIG. 8 provides a schematic diagram of an exemplary networked or distributed computing environment. The distributed computing environment comprises computing objects 810a, 810b, etc. and computing objects or devices 820a, 820b, 820c, 820d, 820e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 840. This network may itself comprise other computing objects and computing devices that provide services to the system of FIG. 8, and may itself represent multiple interconnected networks. In accordance with an aspect of the invention, each object 810a, 810b, etc. or 820a, 820b, 820c, 820d, 820e, etc. may contain an application that might make use of an API, or other object, software, firmware and/or hardware, suitable for use with the systems and methods for synchronizing data groups in accordance with the invention.

It can also be appreciated that an object, such as 820c, may be hosted on another computing device 810a, 810b, etc. or 820a, 820b, 820c, 820d, 820e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to the synchronization protocol of the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 8, as an example, computers 820a, 820b, 820c, 820d, 820e, etc. can be thought of as clients and computers 810a, 810b, etc. can be thought of as servers where servers 810a, 810b, etc. maintain the data that is then synchronized or replicated to client computers 820a, 820b, 820c, 820d, 820e, etc., although any computer can be considered a client, a server, or both, depending on the circumstances. Any of these computing devices may be processing data or requesting services or tasks that may implicate the synchronization protocol in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for synchronizing data groups of the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 8 illustrates an exemplary networked or distributed environment, with server(s) in communication with client computer (s) via a network/bus, in which the present invention may be employed. In more detail, a number of servers 810a, 810b, etc. are interconnected via a communications network/bus 840, which may be a LAN, WAN, intranet, GSM network, the Internet, etc., with a number of client or remote computing devices 820a, 820b, 820c, 820d, 820e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to synchronize data.

In a network environment in which the communications network/bus 840 is the Internet, for example, the servers 810a, 810b, etc. can be Web servers with which the clients 820a, 820b, 820c, 820d, 820e, etc. communicate via any of a number of known protocols such as HTTP. Servers 810a, 810b, etc. may also serve as clients 820a, 820b, 820c, 820d, 820e, etc., as may be characteristic of a distributed computing environment.

As mentioned, communications may be wired or wireless, or a combination, where appropriate. Client devices 820a, 820b, 820c, 820d, 820e, etc. may or may not communicate via communications network/bus 14, and may have independent communications associated therewith. For example, in the case of a TV or VCR, there may or may not be a networked aspect to the control thereof. Each client computer 820a, 820b, 820c, 820d, 820e, etc. and server computer 810a, 810b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 810a, 810b, 820a, 820b, 820c, 820d, 820e, etc. may be responsible for the maintenance and updating of a database 830 or other storage element, such as a database or memory 830 for storing data processed or saved according to the invention. Thus, the present invention can be utilized in a computer network environment having client computers 820a, 820b, 820c, 820d, 820e, etc. that can access and interact with a computer network/bus 840 and server computers 810a, 810b, etc. that may interact with client computers 820a, 820b, 820c, 820d, 820e, etc. and other like devices, and databases 830.

### Exemplary Computing Device

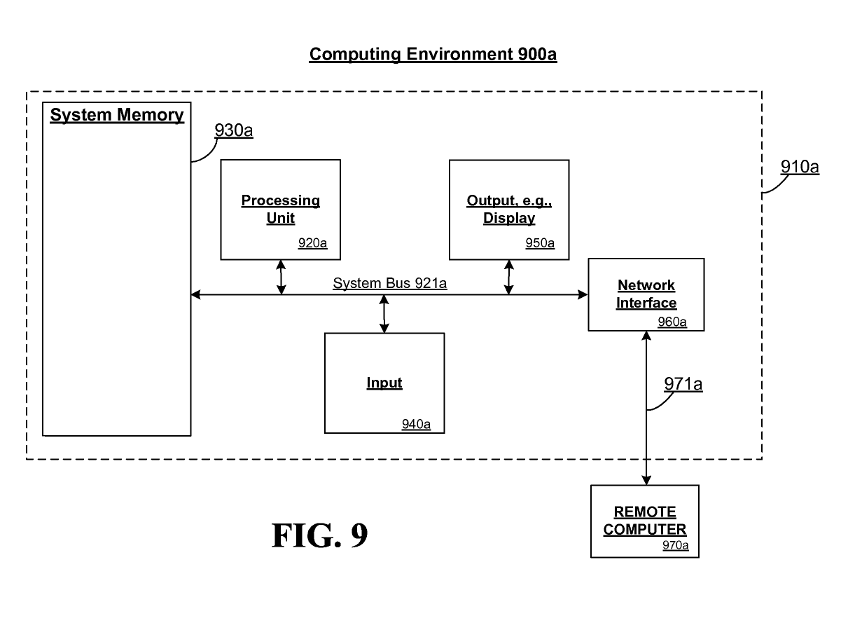

As mentioned, the invention applies to any device wherein it may be desirable to synchronize data. It should be understood, therefore, that handheld, portable and other computing devices and computing objects of all kinds are contemplated for use in connection with the present invention, i.e., anywhere that a device may synchronize data or otherwise receive, process or store data. Accordingly, the below general purpose remote computer described below in FIG. 9 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 9 thus illustrates an example of a suitable computing system environment 900a in which the invention may be implemented, although as made clear above, the computing system environment 900a is only one example of a suitable computing environment for a media device and is not intended to suggest any limitation as to the scope of use or functionality of the invention. Neither should the computing environment 900a be interpreted as having any dependency or requirement relating to any one or combination of components illustrated in the exemplary operating environment 900a.

With reference to FIG. 9, an exemplary remote device for implementing the invention includes a general purpose computing device in the form of a computer 910a. Components of computer 910a may include, but are not limited to, a processing unit 920a, a system memory 930a, and a system bus 921a that couples various system components including the system memory to the processing unit 920a. The system bus 921a may be any of several types of bus structures including a memory bus or memory controller, a peripheral bus, and a local bus using any of a variety of bus architectures.

Computer 910a typically includes a variety of computer readable media. Computer readable media can be any available media that can be accessed by computer 910a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 910a. Communication media typically embodies computer readable instructions, data structures, program modules or other data in a modulated data signal such as a carrier wave or other transport mechanism and includes any information delivery media.

The system memory 930a may include computer storage media in the form of volatile and/or nonvolatile memory such as read only memory (ROM) and/or random access memory (RAM). A basic input/output system (BIOS), containing the basic routines that help to transfer information between elements within computer 910a, such as during start-up, may be stored in memory 930a. Memory 930a typically also contains data and/or program modules that are immediately accessible to and/or presently being operated on by processing unit 920a. By way of example, and not limitation, memory 930a may also include an operating system, application programs, other program modules, and program data.

The computer 910a may also include other removable/non-removable, volatile/nonvolatile computer storage media. For example, computer 910a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 921a through a non-removable memory interface such as an interface, and a magnetic disk drive or optical disk drive is typically connected to the system bus 921a by a removable memory interface, such as an interface.

A user may enter commands and information into the computer 910a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 920a through user input 940a and associated interface(s) that are coupled to the system bus 921a, but may be connected by other interface and bus structures, such as a parallel port, game port or a universal serial bus (USB). A graphics subsystem may also be connected to the system bus 921a. A monitor or other type of display device is also connected to the system bus 921a via an interface, such as output interface 950a, which may in turn communicate with video memory. In addition to a monitor, computers may also include other peripheral output devices such as speakers and a printer, which may be connected through output interface 950a.

The computer 910a may operate in a networked or distributed environment using logical connections to one or more other remote computers, such as remote computer 970a, which may in turn have media capabilities different from device 910a. The remote computer 970a may be a personal computer, a server, a router, a network PC, a peer device or other common network node, or any other remote media consumption or transmission device, and may include any or all of the elements described above relative to the computer 910a. The logical connections depicted in FIG. 9 include a network 971a, such local area network (LAN) or a wide area network (WAN), but may also include other networks/buses. Such networking environments are commonplace in homes, offices, enterprise-wide computer networks, intranets and the Internet.

When used in a LAN networking environment, the computer 910a is connected to the LAN 971a through a network interface or adapter. When used in a WAN networking environment, the computer 910a typically includes a communications component, such as a modem, or other means for establishing communications over the WAN, such as the Internet. A communications component, such as a modem, which may be internal or external, may be connected to the system bus 921a via the user input interface of input 940a, or other appropriate mechanism. In a networked environment, program modules depicted relative to the computer 910a, or portions thereof, may be stored in a remote memory storage device. It will be appreciated that the network connections shown and described are exemplary and other means of establishing a communications link between the computers may be used.

### Exemplary Distributed Computing Architectures

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s managed code platform, i.e., .NET, includes servers, building-block services, such as Web-based data storage and downloadable device software. Generally speaking, the .NET platform provides (1) the ability to make the entire range of computing devices work together and to have user information automatically updated and synchronized on all of them, (2) increased interactive capability for Web pages, enabled by greater use of XML rather than HTML, (3) online services that feature customized access and delivery of products and services to the user from a central starting point for the management of various applications, such as e-mail, for example, or software, such as Office .NET, (4) centralized data storage, which increases efficiency and ease of access to information, as well as synchronization of information among users and devices, (5) the ability to integrate various communications media, such as e-mail, faxes, and telephones, (6) for developers, the ability to create reusable modules, thereby increasing productivity and reducing the number of programming errors and (7) many other cross-platform and language integration features as well.

While some exemplary embodiments herein are described in connection with software, such as an application programming interface (API), residing on a computing device, one or more portions of the invention may also be implemented via an operating system, or a “middle man” object, a control object, hardware, firmware, intermediate language instructions or objects, etc., such that the methods for communicating in accordance with the protocol of the invention may be included in, supported in or accessed via all of the languages and services enabled by managed code, such as .NET code, and in other distributed computing frameworks as well.

There are multiple ways of implementing the present invention, e.g., an appropriate API, tool kit, driver code, operating system, control, standalone or downloadable software object, etc. which enables applications and services to use the systems and methods for synchronizing data of the invention. The invention contemplates the use of the invention from the standpoint of an API (or other software object), as well as from a software or hardware object that implements the protocol of the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to synchronize data. While exemplary programming languages, names and examples are chosen herein as representative of various choices, these languages, names and examples are not intended to be limiting. One of ordinary skill in the art will appreciate that there are numerous ways of providing object code and nomenclature that achieves the same, similar or equivalent functionality achieved by the various embodiments of the invention.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the protocol of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIGS. 2, 3 and 7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide the synchronization communications protocol and methods of the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for synchronizing at least one data group between a server and at least one client, comprising:
connecting to the server by at least one client in order to synchronize with the data of at least one data group of the server; and
requesting synchronization of the at least one data group by the at least one client, wherein said requesting includes transmitting, from the at least one client to the server, synchronization metadata maintained by the at least one client that enables the server to determine a synchronization state of the at least one client.

2. The method according to claim 1, wherein said requesting further includes transmitting, from the at least one client to the server, changes to the at least one data group that have occurred on the at least one client since a prior synchronization time.

3. The method according to claim 1, further including:
receiving updates to the client side version of the at least one data group maintained by the at least one client according to a transport agnostic protocol.

4. The method according to claim 1, further including:
receiving updates to the client side version of the at least one data group maintained by the at least one client according to a web services protocol.

5. The method according to claim 1, further including:
generating a synchronization anchor on the at least one client.

6. The method according to claim 5, further including:
persisting the synchronization anchor on the at least one client in response to acknowledgement of said requesting received from the server.

7. The method according to claim 1, further including:
receiving a synchronization anchor from the server according to an extensible anchor model that allows a plurality of anchor data types with differing features.

8. The method according to claim 1, further including:
receiving a set of synchronization conflicts as determined by the server and handling the set of synchronization conflicts by the client according to at least one conflict resolution policy.

9. The method according to claim 1, further including:
subscribing to the at least one data group by the at least one client based on permissions to the at least one data group.

10. A computer readable medium bearing computer executable instructions for carrying out the method of claim 1.

11. A computing device, comprising:
a synchronization agent for initiating synchronization with at least one data set maintained at a server, wherein the synchronization agent automatically retrieves schema for the at least one data set if the schema is not accessible by the computing device; and
storage means for storing a local version of the at least one data set of the server.

12. The computing device according to claim 11, wherein the synchronization agent discovers from the server at least one data set with which the computing device is permitted to synchronize.

13. The computing device according to claim 11, wherein the synchronization agent initiates synchronization when the computing device connects to the server.

14. The computing device according to claim 11, wherein the synchronization agent collects synchronization metadata from the storage, uploads and downloads changes to and from a server database.

15. The computing device according to claim 11, further comprising:
a client application that communicates with the synchronization agent in order to synchronize with at least one data set of the server, wherein the synchronization agent propagates error, progress and conflict events to the client application.

16. A method for synchronizing at least one data group between a server and a loosely coupled client, comprising:
receiving a request from a client for synchronization with at least one synchronization group of the server including synchronization metadata for determining the synchronization state of the client;
for each synchronization group of the at least one synchronization group,
receiving any changes to the synchronization group from the client;
updating the at least one synchronization group of the server based on the changes including determining any conflicts presented by the changes; and
transmitting an acknowledgement of processing the request and the conflicts to the client for conflict handling by the client.

17. The method of claim 16, further comprising:
based on an analysis of the synchronization metadata received from the client, enumerating client side changes for the at least one synchronization group to transmit to the client that enables the client to update the client version of the at least one synchronization group.

18. The method of claim 17, further comprising:
transmitting the client side changes to the client as a Data Set object.

19. The method of claim 16, further comprising:
defining a synchronization anchor by the server according to server-defined structure; and
transmitting the synchronization anchor from the server to the client according to an extensible anchor model that does not require the server-defined structure to be understood by a consuming client application.

20. A computer readable medium bearing computer executable instructions for carrying out the method of claim 16.
